(19) United States
(12) Patent Application Publication
(10) Pub. No.: US 2018/0151175 A1
(43) Pub. Date: May 31, 2018

(54) Method and System for the Post-Treatment of a Voice Recognition Result

(71) Applicant: ZETES INDUSTRIES S.A., Brussels (BE)

(72) Inventor: Jean-Luc FORSTER, Lasne (BE)

(21) Appl. No.: 15/554,957

(22) PCT Filed: Mar. 2, 2016
(86) PCT No.: PCT/EP2016/054425

§ 371 Date: Feb. 6, 2018

(30) Foreign Application Priority Data
Mar. 6, 2015 (EP) 15157919.0

(51) Int. Cl. G10L 15/19; G10L 15/14; G10L 15/22; G10L 15/26

(52) U.S. Cl. CPC G10L 15/19; G10L 15/265; G10L 15/22; G10L 15/142

(57) ABSTRACT

The invention relates to a method for the post-treatment of a voice recognition result (100), said result (100) comprising a beginning (111), an end (112) and a plurality of elements (113), said method comprising the following steps: reading said result (100); selecting one of the elements (113) thereof; determining whether it is valid; repeating the steps of selecting the element (113) and determining the validity thereof or not; and if at least one element (113) has been determined as being valid, determining a post-treated solution (200) by reusing at least one such valid element (113). The method of the invention is characterised in that said element (113) is selected from said end (112) to said beginning (111) of the result (100) in a consecutive manner.

### FIELD OF THE INVENTION

According to a first aspect, the invention relates to a method for post-processing a speech recognition result. According to a second aspect, the invention relates to a system (or device) for post-processing a speech recognition result. According to a third aspect, the invention relates to a program. According to a fourth aspect, the invention relates to a storage medium (for example: USB stick, CD-ROM or DVD disc) comprising instructions.

### PRIOR ART

A speech recognition engine allows a result to be generated, from a spoken or audio message, that is generally in the form of a text or a code that can be processed by a machine. This technology is currently widespread and is considered to be very useful. Various applications of speech recognition are particularly taught in document U.S. Pat. No. 6,754,629 B1.

Studies exist for improving the results provided by a speech recognition engine. For example, publication US 2014/0278418 A1 proposes using the identity of a speaker to adapt the speech recognition algorithms of a speech recognition engine accordingly. This adaptation of the algorithms occurs within the same speech recognition engine, for example, by modifying its phonetic dictionary in order to take into account how the speaker or user speaks.

A speech recognition result generally comprises a series of elements, for example, words, that are separated by silences. The result is characterised by a beginning and an end and the elements thereof are temporally arranged between this beginning and this end.

A result provided by a speech recognition engine can be used, for example, to enter information into a computer system, for example, an article number or any instruction to be executed. Rather than using a crude speech recognition result, this result sometimes undergoes one or more post-processing operations in order to extract a post-processed solution therefrom. For example, it is possible to browse a speech recognition result from the beginning to the end and to retain, for example, the first five elements considered as being valid, if it is known that the useful information does not comprise more than five elements (an element is a word, for example). Indeed, knowing that the useful information (a code, for example) does not comprise more than five words (five numbers, for example), a decision is then sometimes made to retain only the first five valid elements from a speech recognition result. Any additional subsequent element is considered to be redundant relative to the expected information and is thus considered to be invalid.

Such a post-processing method does not always provide acceptable solutions. Therefore, the inventors have found that in certain cases such a method can result in the generation of a false post-processed solution, i.e. a solution that does not match the information that actually must be provided by the speaker. Therefore, this post-processing method is not reliable enough.

### SUMMARY OF THE INVENTION

According to a first aspect, one of the objects of the invention is to provide a more reliable method for post-processing a speech recognition result. To this end, the inventors propose the following method. Method for post-processing a speech recognition result, said result comprising a beginning, an end and a plurality of elements distributed between said beginning and said end, said post-processing method comprising the following steps:
i) receiving said result;
ii) isolating (or considering, selecting) an element of said plurality of elements that has not undergone the validation test of step iii.a);
iii) then,
   a) if an element has been isolated during step ii), determining whether said element is valid by using a validation test;
   b. otherwise, proceeding directly to step v);
iv) repeating steps ii) and iii) (in the following order: step ii), then step iii));
v) if at least one element has been determined as being valid in step iii.a), determining a post-processed solution using (or reusing) at least one element determined as being valid in step iii.a);
   characterised in that each element isolated in step ii) is selected from said end of the result to said beginning of the result in a consecutive manner (or in a continuous manner, i.e. without skipping an element).

With the method of the invention, a speech recognition result is browsed from the end to the beginning. Indeed, the inventors have discovered that a person dictating a message to a speech recognition engine had a greater tendency to hesitate and/or to err at the beginning rather than at the end. By processing a speech recognition result from the end rather than from the beginning, the method of the invention favours the part of the result with greater chances of having the correct information. In the end, this method is therefore more reliable.

Consider the following example. Suppose that a code to be read is: 4531. The operator, when reading the code, says: “5, 4, um, 4, 5, 3, 1”. Generally, a speech recognition engine will provide a result of either “5, 4, 1, 4, 5, 3, 1” or “5, 4, 4, 5, 3, 1”. In the first case, “um” is associated with “one”; in the second case, the engine does not provide a result for “urn”. Assuming that a post-processing system (which can be integrated into a speech recognition engine) knows that the result must not have more than four good elements (numbers in this case), a post-processing system that browses the result from the beginning to the end of the result will provide the following post-processed solution: 5414 or 5445 (and not 4531). The method of the invention will provide 4531, i.e. the correct solution.

The inventors have noted that the situation illustrated by this example, i.e. the fact that an operator has a greater tendency to hesitate or to err at the beginning rather than at the end of a recorded sequence, is more common than the other way around. Thus, overall, the method of the invention is more reliable as it provides fewer incorrect results. The chances of obtaining a correct post-processed solution are also higher with the method of the invention. Therefore, it is also more efficient.

The method of the invention has other advantages. It is easy to implement. In particular, it does not require many implementation steps. The implementation steps are also simple. These aspects facilitate the integration of the method of the invention, for example, into a computer system using a speech recognition result or on a speech recognition engine, for example.

The post-processing method of the invention can be considered to be a method for filtering a speech recognition result. Indeed, invalid elements are not used to determine the post-processed solution.

A speech recognition result is generally in the form of a text or a code that can be read by a machine. An element of a result represents an item of information from the result that is delimited by two different times along a timescale, t, associated with the result, and that is not considered to be a silence or a background noise. In general, an element is a group of phonemes. A phoneme is known to a person skilled in the art. Preferably, an element is a word. An element can also be a group or a combination of words. An example of a combination of words is ‘cancel operation’.

Within the scope of the invention, there can be different types of speech recognition result. According to a first possible example, a speech recognition result represents a hypothesis provided by a speech recognition engine from a message spoken by a user or speaker. In general, a speech recognition engine provides a plurality (for example, three) of hypotheses from a message spoken by a user. In this case, it also generally provides a score (which can be expressed in various units as a function of the type of speech recognition engine) for each hypothesis. Preferably, the post-processing method of the invention then comprises a preliminary step of only selecting the one or more hypotheses with a score that is greater than or equal to a predetermined score. For example, if the speech recognition engine that is used is the Nuance VoCon® 3200 V3.14 model, said predetermined score is 4000. The steps described above (steps i), ii), iii), iv), v)) are then only applied to results with a score that is greater than or equal to said predetermined score.

According to another possible example, a speech recognition result is a solution, generally comprising a plurality of elements, obtained from one or more post-processing operations applied to one or more hypotheses provided by a speech recognition engine. In this latter example, the speech recognition result thus originates from a speech recognition module and from one or more modules for post-processing one or more hypotheses provided by a speech recognition engine.

If no element has been determined as being valid in step iii.a), step v) preferably comprises a sub-step of providing another post-processed solution. Preferably, this other post-processed solution corresponds to a post-processed solution that does not comprise an element of said result. In this preferred variant, and when no element has been determined as being valid in step iii.a), various examples of a post-processed solution are: empty message, i.e. comprising no element (no word, for example), message stipulating that the post-processing has been unsuccessful. According to another possible variant, this other post-processed solution corresponds to the speech recognition result if no element has been determined as being valid in step iii.a) (no filtering of the result).

Along a timescale t associated with the result (see FIGS. 1 and 2, for example), the beginning of the result is before the end of the result.

Preferably, an element is a word. Examples of a word are: one, two, car, umbrella. According to this preferred variant, the method of the invention provides even better results. Each word is determined from a message spoken by a user via a speech recognition engine using a dictionary. Grammar rules optionally allow the possible choice of words from a dictionary to be reduced.

Preferably, step iii.a), further comprises an instruction to proceed directly to step v) if the element undergoing the validation test of step iii.a) is not determined as being valid. According to this preferred variant, a post-processed solution for which at least one element has been determined as being valid in step iii.a) only comprises consecutive valid elements of the speech recognition engine. The reliability of the method is then further improved as only one series of consecutive valid elements is kept.

Preferably, the method of the invention further comprises the following step: vi) determining whether said post-processed solution of step v) satisfies a grammar rule. By using a grammar rule, the reliability of the method of the invention can be enhanced further. In particular, an abnormal result can be better filtered. An example of a grammar rule is a range of numbers of words allowed for the post-processed solution. For example, a grammar rule can be defined as: the post-processed solution must contain between three and six words.

Preferably, when a grammar rule is used, the method of the invention further comprises the following step:
vii.
a. providing said post-processed solution if the response to the test of step vi) is positive;
b. otherwise, providing said speech recognition result
   According to another possible variant, the method of the invention comprises the following step when a grammar rule is used:
   vii.
a. providing said post-processed solution if the response to the test of step vi) is positive (i.e. the post-processed solution satisfies the grammar rule);
b. not providing a post-processed solution if the response to the test of step vi) is negative (i.e. the post-processed solution does not satisfy the grammar rule), or providing an empty message or providing a message stating that no satisfactory post-processed solution could be determined.

Various validation tests can be designed for step iii.a). For example, the validation test of step iii.a) can comprise a step of considering an element as being valid if its duration is greater than or equal to a lower threshold duration.

Each element of the result has a corresponding duration or time interval that is generally provided by the speech recognition engine. With this preferred embodiment, it is possible to more effectively avoid short duration elements, such as, for example, a spurious noise that can originate from a machine.

According to another example, the validation test of step iii.a) comprises a step of considering an element as being valid if its duration is less than or equal to an upper threshold duration. With this preferred embodiment, it is possible to more effectively avoid long duration elements, such as, for example, a hesitation by a speaker, who says, for example, ‘um’, but for which the speech recognition engine provides the word ‘two’ (for example, because they use a predefined grammar rule that stipulates that only numbers are to be provided). By using this preferred embodiment, it will be easier to eliminate this invalid word ‘two’.

According to another example, said validation test of step iii.a) comprises a step of considering an element as being valid if its confidence factor is greater than or equal to a minimum confidence factor.

The reliability of the method is further enhanced in this case.

According to another example, said validation test of step iii.a) comprises a step of considering an element as being valid if a time interval separating it from another directly adjacent element towards said end of the result is greater than or equal to a minimum time interval.

By virtue of this preferred variant, any elements that are not generated by a human being, but rather by a machine, for example, and which are temporally very close together, can be rejected more effectively.

Preferably, said validation test of step iii.a) comprises a step of considering an element as being valid if a time interval separating it from another directly adjacent element towards said end of the result is less than or equal to a maximum time interval. By virtue of this variant, any elements that are temporally widely separated from each other can be rejected more effectively.

According to another possible variant of the method of the invention, the validation test of step iii.a) comprises a step of considering an element as being valid if a time interval separating it from another directly adjacent element towards said beginning of the result is greater than a minimum (time) interval.

According to another possible variant of the method of the invention, the validation test of step iii.a) comprises a step of considering an element as being valid if a time interval separating it from another directly adjacent element towards said beginning of the result is less than a maximum (time) interval.

Preferably, said validation test of step iii.a) comprises a step of considering, for a given speaker, an element of said result as being valid, if a statistic associated with this element complies with, within a close range, a predefined statistic for the same element and for this given speaker.

The statistic (or speech recognition statistic) associated with said element is generally provided by the speech recognition engine. Examples of statistics associated with an element are: the duration of the element, its confidence factor. Other examples are possible. Such statistics can be recorded for various elements and for various speakers (or operators), for example, during a preliminary registration step. If the identity of the speaker who recorded a statement that corresponds to a result provided by a speech recognition engine is then known, statistics associated with the various elements of said result can be compared to predefined statistics for these elements and for this speaker. In this case, the method of the invention thus preferably comprises an additional step of determining the identity of the speaker.
By virtue of this preferred embodiment, reliability and efficiency are further enhanced, since it is possible to take into account vocal features of the speaker.

Preferably, all the elements determined as being valid in step iii.a) are reused to determine said post-processed solution of step v).

The inventors also propose an optimisation method for providing an optimised solution from a first and a second speech recognition result and comprising the following steps:
A. applying anyone of the post-processing methods as described hereinabove to said first result;
B. applying anyone of the post-processing methods as described hereinabove to said second result;
C. determining said optimised solution from one or more elements that belong to one or more results of said first and second results and that have been determined as being valid by the validation step of step iii.a).

According to a second aspect, the invention relates to a system (or device) for post-processing a speech recognition result, said result comprising a beginning, an end and a plurality of elements distributed between said beginning and said end, said post-processing system comprising:
acquisition means for reading said result;
processing means:
   for repeatedly carrying out the following steps:
      isolating an element of said plurality of elements that has not previously undergone a validation test required by said processing means;
      determining whether the isolated element is valid using a validation test; and
   for determining a post-processed solution by reusing at least one element determined as being valid;
characterised in that each element isolated by the processing means is selected from said end of the result to said beginning in a consecutive manner.

The advantages associated with the method according to the first aspect of the invention are applicable to the system of the invention, mutatis mutandis. Thus, in particular, it is possible to have a more reliable post-processed solution with the system of the invention. It is also possible to have a more efficient system for providing a correct post-processed solution. The various embodiments presented for the method according to the first aspect of the invention are applicable to the system of the invention, mutatis mutandis.

According to a third aspect, the invention relates to a program (preferably a computer program) for processing a speech recognition result, said result comprising a beginning, an end and a plurality of elements distributed between said beginning and said end, said program comprising a code to allow a device (for example, a speech recognition engine, a computer able to communicate with a speech recognition engine) to carry out the following steps:
i) reading said speech recognition result;
ii) isolating an element of said plurality of elements that has not undergone the validation test of step iii.a);
iii) then,
   a. if an element has been isolated in step ii), determining whether said element is valid by using a validation test;
   b. otherwise, proceeding directly to step v);
iii) repeating steps ii) and iii);
iv) if at least one element has been determined as being valid in step iii.a), determining a post-processed solution by reusing at least one element determined as being valid in step iii.a);
   characterised in that each element isolated in step ii) is selected from said end of the result to said beginning of the result in a consecutive manner.

The advantages associated with the method and the system according to the first and second aspects of the invention are applicable to the program of the invention, mutatis mutandis. Thus, in particular, it is possible to have a more reliable post-processed solution with the program of the invention. It is also possible to have a more efficient program for determining a correct post-processed solution. The various embodiments presented for the method according to the first aspect of the invention are applicable to the program of the invention, mutatis mutandis.

If no element has been determined as being valid in step iii.a), step v) preferably comprises the following sub-step: determining a post-processed solution that does not comprise an element of said result. In this preferred variant, and when no element has been determined as being valid in step iii.a), various examples of post-processed solutions are then: empty message, i.e. comprising no element (no word, for example), message stating that the post-processing has been unsuccessful, result provided by the speech recognition engine.

According to a fourth aspect, the invention relates to a storage medium (or recording medium) that can be connected to a device (for example, a speech recognition engine, a computer able to communicate with a speech recognition engine) and comprises instructions, which, when read, allow said device to process a speech recognition result, said result comprising a beginning, an end and a plurality of elements distributed between said beginning and said end, said instructions ensuring that said device carries out the following steps:
i) reading said result;
ii) isolating an element of said plurality of elements that has not undergone the validation test of step iii.a),
iii) then,
   a. if an element has been isolated in step ii), determining whether said element is valid by using a validation test;
   b. otherwise, proceeding directly to step v);
iii) repeating steps ii) and iii);
iv) if at least one element has been determined as being valid in step iii.a), determining a post-processed solution by reusing at least one element determined as being valid in step iii.a);
   characterised in that each element isolated in step ii) is selected from said end of the result to said beginning of the result in a consecutive manner.

The advantages associated with the method and the system according to the first and second aspects of the invention are applicable to the storage medium of the invention, mutatis mutandis. Thus, in particular, it is possible to have a more reliable post-processed solution. It is also possible to more efficiently determine a correct post-processed solution. The various embodiments presented for the method according to the first aspect of the invention are applicable to the storage medium of the invention, mutatis mutandis.

If no element has been determined as being valid in step iii.a), step v) preferably comprises the following sub-step: determining a post-processed solution that does not comprise an element of said result. In this preferred variant, and when no element has been determined as being valid in step iii.a), various examples of post-processed solutions are then: empty message, i.e. comprising no element (no word, for example), message stating that the post-processing has been unsuccessful, result provided by the speech recognition engine.

### BRIEF DESCRIPTION OF THE DRAWINGS

These aspects and other aspects of the invention will become apparent in the detailed description of particular embodiments of the invention, with reference to the accompanying drawings, in which:

FIG. 1 schematically shows a speaker speaking a message that is processed by a speech recognition engine;

FIG. 2 schematically shows an example of a speech recognition result;

FIG. 3 schematically shows various steps of a preferred variant of the method of the invention and their interaction;

FIG. 4 schematically shows an example of a post-processing system according to the invention.

The drawings in the Fig. are not to scale. In general, similar elements are denoted using similar reference numerals in the Fig. The presence of reference numerals on the drawings cannot be considered to be limiting, even when these numbers are indicated in the claims.

### DETAILED DESCRIPTION OF PARTICULAR EMBODIMENTS

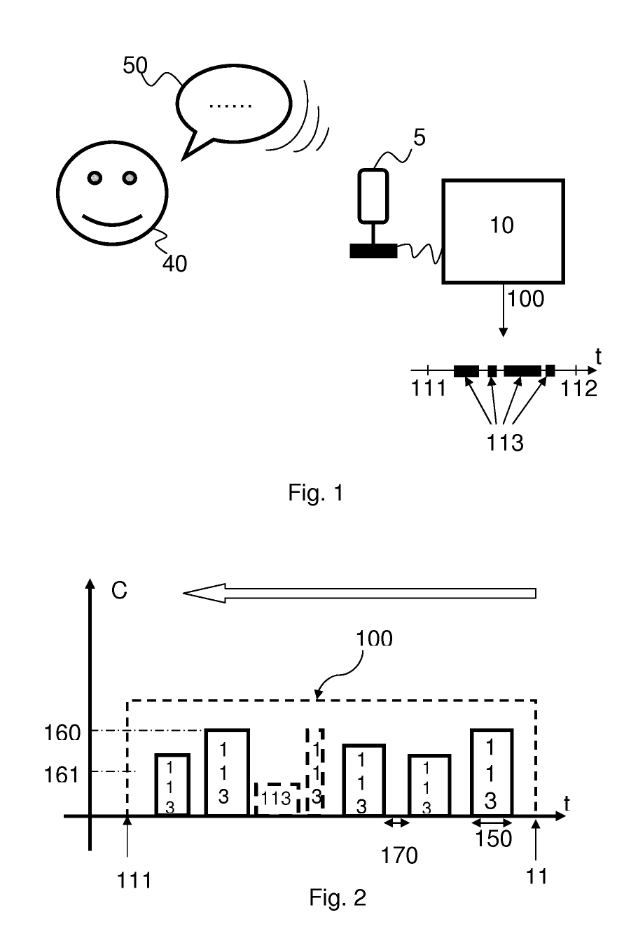

FIG. 1 shows a speaker 40 (or user 40) speaking a message 50 into a microphone 5. This message 50 is then transferred to a speech recognition engine 10, which is known to a person skilled in the art. Various models and various brands are available on the market. In general, the microphone 5 forms part of the speech recognition engine 10. This speech recognition engine processes the message 50 with speech recognition algorithms based on a Hidden Markov Model (HMM), for example. This leads to a speech recognition result 100. An example of a result 100 is a hypothesis generated by the speech recognition engine 10. Another example of a result 100 is a solution obtained from speech recognition algorithms and from post-processing operations, which are applied, for example, to one or more hypotheses generated by the speech recognition engine 10. Post-processing modules for providing such a solution can form part of the speech recognition engine 10. The result 100 is generally in the form of a text, which can be decoded by a machine, a computer or a processing unit, for example. The result 100 is characterised by a beginning 111 and an end 112. The beginning 111 is before said end 112 along a timescale, t. The result 100 comprises a plurality of elements 113 temporally distributed between the beginning 111 and the end 112. An element 113 represents an item of information included between two different times along the timescale, t. In general, the various elements 113 are separated by portions of the result 100 representing a silence, a background noise or a time interval, during which no element 113 (word, for example) is recognised by the speech recognition engine 10.

The method of the invention relates to the post-processing of a speech recognition result 100. In other words, the input of the method of the invention corresponds to a result 100 that is obtained from speech recognition algorithms applied to a message 50 spoken by a speaker 40 (or user 40). FIG. 2 shows a speech recognition result 100. Between its beginning 111 and its end 112, the result 100 comprises a plurality of elements 113, seven in the case shown in FIG. 2. In this Fig., the elements 113 are shown as a function of time, t (abscissa). The ordinate, C, represents a confidence level or factor. This notion is known to a person skilled in the art. It involves a property or statistic generally associated with each element 113 and which generally can be provided by a speech recognition engine 10. In general, a confidence factor represents a probability that an element of the speech recognition result, which is determined by a speech recognition engine 10 from a spoken element, is the correct element. This property is known to a person skilled in the art. An example of a speech recognition engine is the Nuance VoCon® 3200 V3.14 model. In this case, the confidence factor varies between 0 and 10000. A value of 0 relates to a minimum value of a confidence factor (very low probability that the element of the speech recognition result is the correct element) and 10000 represents a maximum value of a confidence factor (very high probability that the element of the speech recognition result is the correct element). The height of an element 113 in FIG. 2 indicates whether its confidence factor 160 is higher or lower.

The first step of the method of the invention, step i), consists in receiving the result 100. Then, beginning from the end 112, the method will isolate a first element 113. The method of the invention therefore will firstly isolate the last element 113 of the result along the timescale, t. Once this element 113 is selected, the method determines whether it is valid by using a validation test. Various examples of validation tests are presented hereafter. The method then proceeds to the second element 113, starting from the end 112, and so on. According to a possible version of the method of the invention, all the elements 113 of the result 100 are thus browsed in the direction of the arrow shown at the top of FIG. 2 and this stops when the first element 113 along the timescale, t, has been determined as being valid or invalid. According to another preferred variant, browsing the elements 113 of the result 100 in the direction of the arrow at the top of FIG. 2 stops as soon as an invalid element 113 has been detected. A post-processed solution 200 is then determined by reusing elements 113 that have been determined as being valid, preferably, by using all the elements 113 that have been determined as being valid. When determining the post-processed solution 200, the correct order of the various elements 113 selected along a timescale, t, must be maintained. Thus, it is important to take into account the fact that the first element 113 processed by the method of the invention represents the last element 113 of the message 100 and thus that it must be in last position in the post-processed solution 200 if it has been determined as being valid. In general, a speech recognition engine 10 provides, with the various elements 113 of the message 100, associated time information, for example the beginning and the end of each element 113. This associated time information can be used to classify the elements determined as being valid in step iii.a) in the correct order, i.e. in an ascending chronological order.

Preferably, the method of the invention comprises a step of verifying that the post-processed solution 200 satisfies a grammar rule. An example of a grammar rule is a number of words. If the post-processed solution 200 does not satisfy such a grammar rule, a decision can be made not to provide said solution. In this case, it is sometimes preferable for the result 100 of the speech recognition engine 10 to be provided. If the post-processed solution 200 satisfies such a grammar rule, it is preferable that said solution is provided.

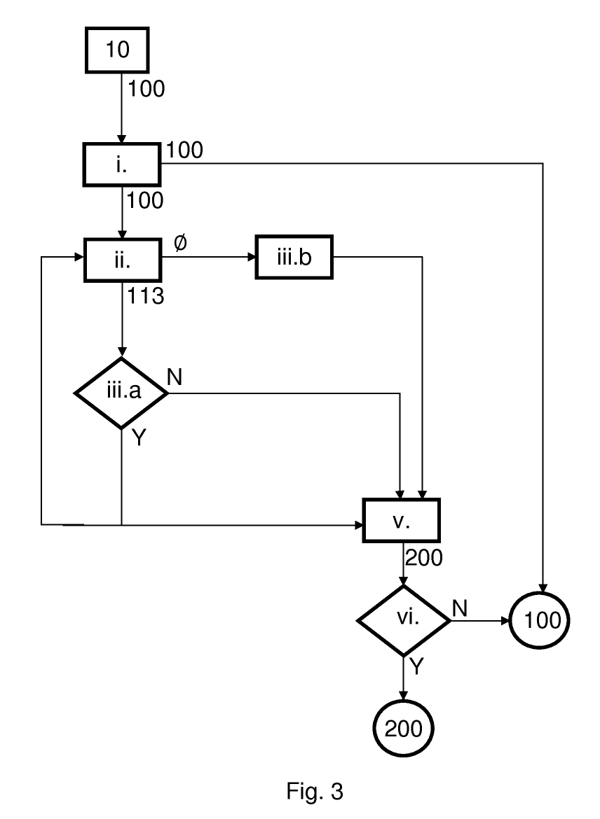

FIG. 3 schematically shows a preferred version of the method of the invention, in which:
the isolating (or selecting) of an additional element 113 is stopped so that it can undergo the validation test when an invalid element 113 has been detected; in which,
the post-processed solution 200 is verified to determine whether it satisfies a grammar rule (step vi)); in which,
the post-processed solution 200 is provided if it satisfies said grammar rule; and in which,
the result 100 of the speech recognition engine 10 is provided if the post-processed solution 200 does not satisfy said grammar rule.

Step iii.a) consists in determining whether an element 113 selected in step ii) is valid by using a validation test. This test can take several forms.

An element 113 is characterised by a beginning and an end. It thus has a certain duration 150. According to a possible variant, the validation test comprises a step of considering an element 113 as being valid if its duration 150 is greater than or equal to a lower duration threshold. The lower duration threshold is between 50 and 160 milliseconds, for example. Preferably, the lower duration threshold is 120 milliseconds. The lower duration threshold can be dynamically adapted. According to another possible variant, the validation test comprises a step of considering an element 113 as being valid if its duration 150 is less than or equal to an upper duration threshold. The upper duration threshold is between 400 and 800 milliseconds, for example. Preferably, the upper duration threshold is 600 milliseconds. The upper duration threshold can be dynamically adapted. Preferably, the lower duration threshold and/or the upper duration threshold is/are determined by a grammar rule.

In general, a confidence factor 160 is associated with each element 113. According to another possible variant, the validation test comprises a step of considering an element 113 as being valid if its confidence factor 160 is greater than or equal to a minimum confidence factor 161. Preferably, this minimum confidence factor 161 can dynamically vary. In such a case, it is then possible for the minimum confidence factor 161 used to determine whether an element 113 is valid to be different to that used to determine whether or not another element 113 is valid. The inventors have found that a minimum confidence factor 161 between 3500 and 5000 provided good results, with an even more preferred value being 4000 (which are the values for the Nuance VoCon® 3200 V3.14 model, but which can be applied to other models of speech recognition engines).

According to another possible variant, the validation test comprises a step of considering an element 113 as being valid if a time interval 170 separating it from another directly adjacent element 113 towards the end 112 of the result 100 is greater than or equal to a minimum time interval. Such a minimum time interval is between zero and 50 milliseconds, for example. According to another possible variant, the validation test comprises a step of considering an element 113 as being valid if a time interval 170 separating it from another directly adjacent element 113 towards the end 112 of the result 100 is less than or equal to a maximum time interval. Such a maximum time interval is between 300 and 600 milliseconds, for example, and a preferred value is 400 ms. For these two examples of validation tests, the time interval 170 is thus considered that separates an element 113 from its immediate neighbour towards the right-hand side of FIG. 2. In other words, the time interval is considered that separates an element 113 from its immediate right-hand side neighbour, i.e. its subsequent neighbour along the timescale, t. A time interval separating two elements 113 is, for example, a time interval during which a speech recognition engine 10 does not recognise an element 113, for example, no word.

According to another possible variant, the validation test is adapted to the speaker 40 (or user) who recorded the message 50. Every individual pronounces elements 113 or words in a particular manner. For example, some individuals pronounce words slowly, whereas others pronounce them quickly. Similarly, a confidence factor 160 associated with a word and provided by a speech recognition engine 10 generally depends on the speaker 40 who pronounced this word. If one or more statistics associated with various elements 113 are known for a given speaker 40, they can be used during the validation test of step iii.a) to determine whether or not an element 113 is valid. For example, an element 113 spoken by a given speaker 40 can be considered as being valid if one or more statistics associated with this element 113 is/are compliant, within a tight error band (10%, for example), with the same statistics predefined for said element 113 for said speaker 40. This preferred variant of the validation test requires knowing the identity of the speaker 40. This can be provided by the speech recognition engine 10, for example. According to another possibility, the post-processing method of the invention comprises a step of identifying the speaker 40.

In FIG. 2, elements 113 considered as being valid are delimited by continuous lines, whereas elements not considered as being valid are delimited by broken lines. The fourth element 113, starting from the end 112, is, for example, considered as being invalid since its duration 150 is shorter than a lower duration threshold. The fifth element 113, starting from the end 112, is, for example, considered as being invalid since its confidence factor 160 is less than a minimum confidence factor 161.

The inventors further propose a method for generating an optimised solution from a first and a second speech recognition result 100 and comprising the following steps:
A. applying a post-processing method according to the first aspect of the invention to said first result 100;
B. applying a post-processing method according to the first aspect of the invention to said second result 100;
C. determining said optimised solution from one or more elements 113 that belong to one or more results 100 of said first and second results 100 and that have been determined as being valid by the validation step of step iii.a).

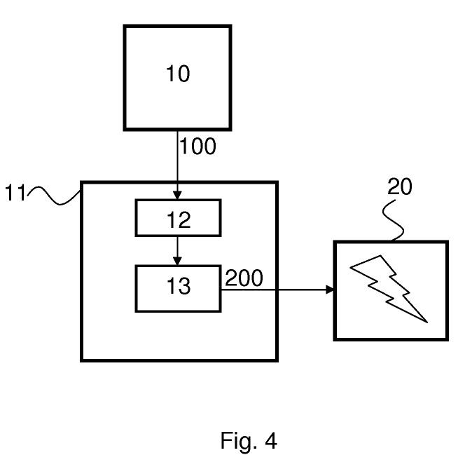

According to a second aspect, the invention relates to a post-processing system 11 or to a device for post-processing a speech recognition result 100. FIG. 4 schematically shows such a post-processing system 11 in combination with a speech recognition engine 10 and a screen 20. In this Fig., the post-processing system 11 and the speech recognition engine 10 are two separate devices. According to another possible version, the post-processing system 11 is integrated into a speech recognition engine 10 such that they cannot be differentiated. In such a case, a conventional speech recognition engine 10 is modified or adapted to be able to carry out the functions of the post-processing system 11 described hereafter.

Examples of a post-processing system 11 are: a computer, a speech recognition engine 10 adapted or programmed to be able to carry out a post-processing method according to the first aspect of the invention, a hardware module of a speech recognition engine 10, a hardware module able to communicate with a speech recognition engine 10. Other examples are nonetheless possible. The post-processing system 11 comprises acquisition means 12 for receiving and reading a speech recognition result 100. Examples of acquisition means 12 are: an input port of the post-processing system 11, for example a USB port, an Ethernet port, a wireless port (for example, Wi-Fi). Other examples of acquisition means 12 are nonetheless possible. The post-processing system 11 further comprises processing means 13 for repeatedly carrying out the following steps: isolating, from the end 112 to the beginning 111 of the result 100, an element 113 of the result 100 that has not previously undergone a validation test by the processing means 13, determining whether said element is valid by using a validation test, determining a post-processed solution 200 by reusing at least one element 113 determined as being valid by said processing means 13. Preferably, said processing means 13 determine a post-processed solution 200 by reusing all the elements 113 determined as being valid by said processing means 13. Preferably, the post-processing system 11 is able to send the post-processed solution 200 to a screen 20 in order to display said solution.

Examples of processing means 13 are: a control unit, a processor or central processing unit, a controller, a chip, a microchip, an integrated circuit, a multicore processor. Other examples that are known to a person skilled in the art are nonetheless possible. According to one possible version, the processing means 13 comprise various units for carrying out the various steps stipulated above in conjunction with these processing means 13 (isolating an element 113, determining whether it is valid, determining a post-processed solution 200).

According to a third aspect, the invention relates to a program, preferably a computer program. Preferably, this program forms part of a human-machine voice interface.

According to a fourth aspect, the invention relates to a storage medium that can be connected to a device, for example, a computer, able to communicate with a speech recognition engine 10. According to another possible variant, this device is a speech recognition engine 10. Examples of a storage medium according to the invention are: a USB stick, an external hard drive, a CD-ROM. Other examples are nonetheless possible.

The present invention has been described with respect to specific embodiments, which are purely for illustrative purposes and must not be considered to be limiting. In general, the present invention is not limited to the examples illustrated and/or described above. The use of the verbs “comprise”, “include”, “consist in”, or any other variant, as well as their conjugations, can by no means exclude the presence of elements other than those mentioned. The use of the indefinite article “a”, “an” or of the definite article “the”, to introduce an element does not exclude the presence of a plurality of these elements. The reference numerals in the claims do not limit their scope.

In summary, the invention can also be described as follows: Method for post-processing a speech recognition result 100, said result 100 comprising a beginning 111, an end 112 and a plurality of elements 113, said method comprising the following steps: reading said result 100; selecting one of the elements 113 thereof; determining whether said element is valid; repeating the steps of selecting the element 113 and determining the validity or invalidity thereof; and if at least one element 113 has been determined as being valid, determining a post-processed solution 200 by reusing at least one element 113 determined as being valid. The method of the invention is characterised in that each element 113 is selected from said end 112 to said beginning 111 of the result 100 in a consecutive manner.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. Method for post-processing a speech recognition result, said result comprising a beginning, an end and a plurality of elements distributed between said beginning and said end, said post-processing method comprising the following steps:
i. receiving said result;
ii. isolating an element of said plurality of elements that has not undergone the validation test of step iii.a.;
iii. then,
a. if an element has been isolated during step ii., determining whether said element is valid by using a validation test;
b. otherwise, proceeding directly to step v.;
iv. repeating steps ii. and iii.;
v. if at least one element has been determined as being valid in step iii.a., determining a post-processed solution using at least one element determined as being valid in step iii.a.;
wherein each element isolated in step ii. is selected from said end of the result to said beginning of the result in a consecutive manner.

17. Method according to claim 1, wherein said elements are words.

18. Method according to claim 1, wherein step iii.a. further comprises an instruction for proceeding directly to step v. if the element undergoing the validation test of step iii.a. is not determined as being valid.

19. Method according to claim 1, further comprising the following step:
vi. determining whether said post-processed solution of step v. satisfies a grammar rule.

20. Method according to claim 19, further comprising the following step: vii.
a. providing said post-processed solution if the response to the test of step vi. is positive;
b. otherwise, providing said speech recognition result.

21. Method according to claim 1, wherein said validation test of step iii.a. comprises a step of considering an element as being valid if its duration is higher than or equal to a lower duration threshold.

22. Method according to claim 1, wherein said validation test of step iii.a. comprises a step of considering an element as being valid if its duration is less than or equal to an upper duration threshold.

23. Method according to claim 1, wherein each element of said result is characterised by a confidence factor, and in that said validation test of step iii.a. comprises a step of considering an element as being valid if its confidence factor is greater than or equal to a minimum confidence factor.

24. Method according to claim 1, wherein said validation test of step iii.a. comprises a step of considering an element as being valid if a time interval separating it from another directly adjacent element towards said end of the result is greater than or equal to a minimum time interval.

25. Method according to claim 1, wherein said validation test of step iii.a. comprises a step of considering, for a given speaker, an element of said result as being valid if a statistic associated with said element complies with, within a close range, a predefined statistic for the same element and for this given speaker.

26. Method according to claim 1, wherein all the elements determined as being valid in step iii.a. are reused to determine said post-processed solution of step v.

27. A method for determining an optimised solution from a first and a second speech recognition result and comprising the following steps:
A. applying a post-processing method of claim 16 to said first result;
B. applying a post-processing method of claim 16 to said second result;
C. determining said optimised solution from one or more elements that belong to one or more results of said first and second results and that have been determined as being valid by the validation test of step iii.a.

28. A system for post-processing a speech recognition result, said result comprising a beginning, an end and a plurality of elements distributed between said beginning and said end, said system comprising:
acquisition means for reading said result;
processing means:
for repeatedly carrying out the following steps:
isolating an element of said plurality of elements that has not previously undergone a validation test required by said processing means;
determining whether the isolated element is valid using a validation test; and
for determining a post-processed solution by reusing at least one element determined as being valid;
wherein each element isolated by the processing means is selected from said end of the result to said beginning of the result in a consecutive manner.

29. A program for processing a speech recognition result, said result comprising a beginning, an end and a plurality of elements distributed between said beginning and said end, said program comprising a code to allow a device to carry out the following steps:
i. reading said speech recognition result;
ii. isolating an element of said plurality of elements that has not undergone the validation test of step iii.a.;
iii. then,
a. if an element has been isolated in step ii., determining whether said element is valid by using a validation test;
b. otherwise, proceeding directly to step v.;
iv. repeating steps ii. and iii.;
v. if at least one element has been determined as being valid in step iii.a., determining a post-processed solution by reusing at least one element determined as being valid in step iii.a.;
wherein each element isolated in step ii) is selected from said end of the result to said beginning of the result in a consecutive manner.

30. A storage medium adapted for connection to a device and which
comprises instructions, which, when read, allow said device to process a speech recognition result, said result comprising a beginning, an end and a plurality of elements distributed between said beginning and said end, said instructions ensuring that said device carries out the following steps:
i. reading said result;
ii. isolating an element of said plurality of elements that has not undergone the validation test of step iii.a.;
iii. then,
a. if an element has been isolated in step ii., determining whether said element is valid by using a validation test;
b. otherwise, proceeding directly to step v.;
iv. repeating steps ii. and iii.;
v. if at least one element has been determined as being valid in step iii.a.,
determining a post-processed solution by reusing at least one element determined as being valid in step iii.a.;
wherein each element isolated in step ii. is selected from said end of the result to said beginning of the result in a consecutive manner.
